(19) United States
(12) Patent Application Publication
(10) Pub. No.: US 2011/0258294 A1
(43) Pub. Date: Oct. 20, 2011

(54) METHOD, APPARATUS, AND SYSTEM FOR PROCESSING MEDIA DATA

(75) Inventors: Jiying Dui, Nanjing (CN); Chunrong Yue, Nanjing (CN); Jian Chen, Nanjing (CN)

(73) Assignee: Huawei Technologies Co., Ltd., Shenzhen (CN)

(21) Appl. No.: 13/168,318

(22) Filed: Jun. 24, 2011

Related U.S. Application Data
(63) Continuation of application No. PCT/CN2009/073597, filed on Aug. 28, 2009.

(30) Foreign Application Priority Data
Dec. 26, 2008 (CN) 200810241865.1

(51) Int. Cl. G06F 15/16

(52) U.S. Cl. 709/219

(57) ABSTRACT

A media data processing method and apparatus are disclosed. The method includes: by a media server, receiving a play request which carries information of media content to be played; obtaining information of a related source server according to the information of the media content to be played and obtaining related media data from a locally stored media data segment; determining start time and/or end time of a media data segment to be obtained from the source server according to play time of the locally stored media data segment; and obtaining the media data segment from the source server according to the determined start time and/or end time of the media data segment. The invention prevents unnecessary transmission of media data and reduces the load of the server.

### CROSS-REFERENCE TO RELATED APPLICATIONS

This application is a continuation of International Application No. PCT/CN2009/073597, filed on Aug. 28, 2009, which claims priority to Chinese Patent Application No. 200810241865.1, filed on Dec. 26, 2008, both of which are hereby incorporated by reference in their entireties.

### FIELD OF THE INVENTION

The present invention relates to the communications field, and in particular, to a method, an apparatus, and a system for processing media data.

### BACKGROUND OF THE INVENTION

To provide streaming services, a media server must obtain streamed media data from a source server. In the prior art, the media server obtains streamed media data from the source server in play-cache-delivery mode. This means, the media server has only partial data or no data of media and when a user requests the media through a terminal, the media server checks whether the requested media data is available locally, and if the requested media data is unavailable locally, the media server obtains the requested media data from the designated source server and forwards the data to the terminal.

If the media server already stores a part of the requested media data and requests the rest of the media data from the source server, the amount of media data obtained from the source server is often larger than that actually required by the play request.

### SUMMARY OF THE INVENTION

Embodiments of the invention provide a media data processing method and apparatus to reduce unnecessary transmission of media data and relieve the load of a server in a streaming service process.

A media data processing method includes:

receiving a play request which carries information of media content to be played;

obtaining information of a source server according to the information of the media content to be played and obtaining media data from a locally stored media data segment;

determining, according to play time of the locally stored media data segment, start time and/or end time of a media data segment to be obtained from the source server; and

obtaining, according to the determined start time and/or end time of the media data segment, the media data segment from the source server.

A media server includes:

a play request receiving unit, configured to receive a play request which carries information of media content to be played; and

a data obtaining unit, configured to: obtain, according to the information of the media content to be played, information of a related source server and media data from a locally stored media data segment; determine, according to play time of the locally stored media data segment, start time and/or end time of a media data segment to be obtained from the source server; and obtain, according to the determined start time and/or end time of the media data segment, the media data segment from the source server.

A media data processing method includes:

receiving a media data obtaining request which carries feature data;

determining a play unit to be sent according to the media data obtaining request;

checking whether feature data of the play unit to be sent matches the feature data in the request; and

sending media data from a play unit next to the play unit whose feature data matches that in the media data obtaining request if the feature data of the play unit to be sent matches the feature data in the request.

A source server includes:

a request receiving unit, configured to receive a media data obtaining request which carries feature data;

a determining unit, configured to determine a play unit to be sent according to the media data obtaining request;

a checking unit, configured to check whether feature data of the play unit to be sent matches the feature data in the media data obtaining request; and

a sending unit, configured to send media data from a play unit next to the play unit whose feature data matches that in the media data obtaining request.

A media data processing system includes a media server and a source server.

The media data processing method, apparatus and system provided in the embodiments of the invention determine the start time and/or end time of the media data segment to be obtained from the source server according to the play time of the locally stored media data segment, which reduces unnecessary transmission of media data and relieves the load of the server.

### BRIEF DESCRIPTION OF THE DRAWINGS

FIG. 1 is a flowchart of the media data processing method in a first embodiment of the invention;

FIG. 2 illustrates a structure of the media server in the media data processing method in a first embodiment of the invention;

FIG. 3 illustrates a structure of the media server in the media data processing method in a second embodiment of the invention;

FIG. 4 is a flowchart of the media data processing method in the second embodiment of the invention;

FIG. 5 illustrates a structure of the source server in the media data processing method in the second embodiment of the invention; and

FIG. 6 illustrates a structure of the media data processing system in the media data processing method in the second embodiment of the invention.

### DETAILED DESCRIPTION OF THE EMBODIMENTS

To better explain the purpose, technical solution, and benefits of the invention, the embodiments of the invention are described in detail with reference to the accompanying drawings. It is understandable that the invention is not limited to such embodiments.

### Embodiment 1 of the Media Data Processing Method

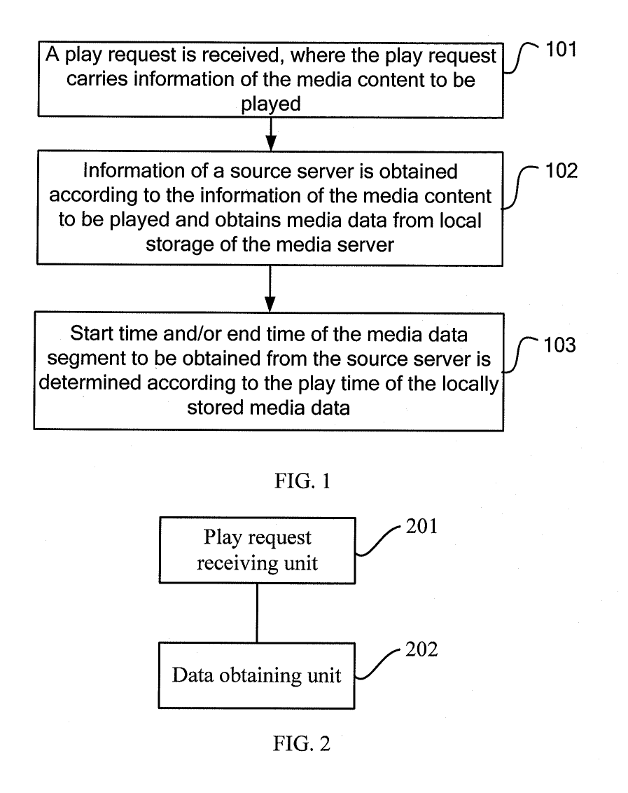

FIG. 1 is a flowchart of the media data processing method in a first embodiment of the invention. The method includes the following steps:

Step 101: A play request is received, where the play request carries information of the media content to be played.

A terminal sends the play request to the media server. The play request carries information of the media content to be played. The media content information includes an identification of demanded content (the media content to be played), such as a filename of the media content or a Uniform Resource Locator (URL) of the media content. The play request also includes the start time, end time, and play speed of the demanded content.

Step 102: Information of a source server is obtained according to the information of the media content to be played and obtains media data from local storage of the media server.

After the media server receives the play request, the media server checks whether the media data or partial media data of the media content is already stored locally according to the identification of the media content to be played, and if so, the media data is already stored locally, the media server obtains the locally stored media data and checks information of the related source server including the address and port information of the source server according to the identification of the media data.

Step 103: Start time and/or end time of the media data segment to be obtained from the source server is determined according to the play time of the locally stored media data.

The locally stored media data may be stored in the form of one or more media data segments. A media data segment is a segment of media data that may be continuously played. One media data segment may be stored in the media server in the form of multiple media data slices. If multiple media data slices, when connected up, create a non-stop media data set that can be continuously played, the multiple media data slices form a media data segment.

One media data segment may include multiple play units. Because non-key frames cannot be decoded and presented independently, when the media server locates media data according to the terminal's play request, the media server normally locates a first key frame that meets the condition according to the play range in the play request and then plays all media data (including key frames and non-key frames) subsequent to the first key frame. For easy description, in the embodiments of the invention, the media data starting from one key frame (I1) and ending before a next key frame (I2) is referred to as a play unit. This is shown in Table 1.

TABLE 1

| | | | | | | | | | |
|---|---|---|---|---|---|---|---|---|---|
| . . . | I₁ | B₁ | P₁ | P₂ | I₂ | B₂ | P₃ | I₃ | . . . |

Table 1 shows a continuous media stream, where I1, B1, P1, and P2 form a play unit and I2, B2, and P3 form another play unit. The play start time of a play unit is defined as the play start time of the first frame in the play unit. The play end time of a play unit is defined as the play end time of the last frame in the play unit. For example, the play start time of the play unit made up of I1, B1, P1, and P2 is the play start time of I1, and its play end time is the play end time of P2.

No two media data segments are successive. For example, a first media data segment stores the media data of play units 0-10; a second media data segment stores the media data of play units 15-20; and a third media data segment stores the media data of play units 30-50.

If the information of the media content to be played does not include the start time of the media content to be played, the default start time is set as the play start time of the entire media content.

If the information of the media content to be played does not include the end time of the media content to be played, the default end time is set as the play end time of the entire media content. The media server determines the start time and/or end time of the media data segment obtained from the source server according to the play time of the locally stored media data segment and the default start time and end time.

If the default media data to be played is the entire media content, for example, play unit 0-50, the play start time is the start time of play unit 0 and the play end time is the end time of play unit 50. Therefore, the media server needs to obtain the media data segments of play units 11-14 and play units 21-29 from the source server. In one mode, when the media server obtains media data from the source server, the media server may use the play start time of play unit 10 and play unit 20 as the respective start time of the two media data segments to be obtained and use the play end time of play unit 15 and play unit 30 as the respective end time of the two media data segments to be obtained. Therefore, more than one value of start time or end time may be determined by the media server, but matches the number of media data segments to be obtained from the source server.

In some cases, it is unnecessary to obtain the start time or end time of a certain media data segment according to the play time of a locally stored media data segment. For example, the start time of the media data segment is the start time of the entire media content to be played. As in the above example, the media content to be played is play units 12-18, and because play units 15-18 are locally stored, the media data segment to be obtained is play units 12-14. Therefore, the media server needs to determine only the end time of the media data segment to be obtained. Similarly, when the end time of the media data segment is the end time of the entire media content to be played, the media server needs to determine only the start time of the media data segment to be obtained according to the play time of the locally stored media data segment.

If the information of the media content to be played in step 101 includes the start time and end time of the media content to be played, the media server determines the start time and/or end time of the media data segment to be obtained from the source server according to the play time of the locally stored media content segment and the start time and end time of the media content to be played.

As in the above example, the play request requests playing the media data of play units 2-28. Then, the media server needs to obtain the media data of play units 11-14 and play units 21-28 from the source server. The obtaining method is the same as above except that the end time of play unit 28 is used as the final end time of the media data to be obtained.

Step 104: The media data segment is obtained from the source server according to the determined start time and end time of the media data segment.

In the media data processing method provided according to the embodiment of the invention, the media data segment is obtained from the source server according to the start time and end time of the media data segment to be obtained from the source server, where the start time and end time of the media data segment to be obtained from the source server are determined according to play time of the locally stored media data segment. It is unnecessary to obtain the entire media data slices according to a predetermined granularity. therefore reducing unnecessary transmission of media data, and relieving the network transmission load and server load.

In step 104, when the media server obtains a media data segment from the source server, the media server may obtain the data from the source server over a standard play control protocol. The standard play control protocol, such as the Real-Time Streaming Protocol (RTSP), Session Initiation Protocol (SIP), Routing Table Maintenance Protocol (RTMP), and Hypertext Transfer Protocol (HTTP), allows the terminal to specify the period of content to be played and the play speed. Therefore, if the user requested data is unavailable locally, the media server can calculate the start time and end time of the requested data in the entire content and use the start time and end time as parameters of play request sent to the source server and send the play request sent to the source server to the source server over the standard protocol. The use of standard protocols to request the source server to play the user requested data facilitates the interconnection between systems of different suppliers and reduces the research and development (R&D) investment caused by the development of a private protocol. The storage of media content in the source server is transparent to the media server so that the media server is independent on the media content storage mode of the source server when the media server obtains media content.

In the media data processing method of the embodiment of the invention, in step 103, the media server may use the play start time of the last play unit in the n^{th} locally stored media data segment as the start time of the media data segment to be obtained from the source server. Here, n is a natural number.

Table 2 shows some exemplary locally stored media data segments.

TABLE 2

| | | | | | | | | | | |
|---|---|---|---|---|---|---|---|---|---|---|
| Play Unit SN | 0 | 1 | 2 | 3 | 4 | 5 | 6 | 7 | 8 | 9 |
| Timestamp Stored by | 0 | 1 | 2 | 3 | 4 | 5 | 6 | 7 | 8 | 9 |
| Source Server | | | | | | | | | | |
| Play Unit SN | 0 | 1 | 2 | | | | 6 | 7 | 8 | 9 |
| Timestamp Stored by | 0 | 1 | 2 | | | | 6 | 7 | 8 | 9 |
| Media Server | | | | | | | | | | |

As shown in Table 2, the media server stores two media data segments locally, including the media data segment of play units 0-2 and the media data segment of play units 6-9. In this case, the media data segment to be obtained from the source server needs to include play units 3-5. If the locally stored media data segments and the media data segment to be obtained from the source server are numbered sequentially, the locally stored media data segment of play units 0-2 is the first media data segment, the segment to be obtained from the source server is the second media data segment, and the locally stored segment of play units 6-9 is the third media data segment. Then, the media server can use the play start time of the last play unit in the first media data segment (that is, play unit 2) as the start time of the media data segment to be obtained from the source server; and the media server can use the play start time of the first play unit in the locally stored the third media data segment (that is, play unit 6) as the end time of the second media data segment to be obtained from the source server.

In the media data processing method of the embodiment of the invention, the media server may use the play start time of the first play unit in the (n+1)^{th} locally stored media data segment as the end time of the n^{th} media data segment to be obtained from the source server.

For example, the media server stores the data of play units 5-9, as shown in Table 3.

TABLE 3

| | | | | | | | | | | |
|---|---|---|---|---|---|---|---|---|---|---|
| Play Unit SN | 0 | 1 | 2 | 3 | 4 | 5 | 6 | 7 | 8 | 9 |
| Timestamp Stored by | 0 | 1 | 2 | 3 | 4 | 5 | 6 | 7 | 8 | 9 |
| Source Server | | | | | | | | | | |
| Play Unit SN | | | | | | 5 | 6 | 7 | 8 | 9 |
| Timestamp Stored by | | | | | | 5 | 6 | 7 | 8 | 9 |
| Media Server | | | | | | | | | | |

The play request of the terminal requests playing the media from the beginning. This means that the media server needs to play first five seconds of media content from the source server before switching to the locally stored media data. If there is data lost in the first five seconds, the media server is unable to determine accurately when to stop obtaining data from the source server to switch to the locally stored media data.

To solve the problem, the media server may first parse a locally stored slice file to obtain the play start time of the first play unit (play unit 5 in the example) and then use the play start time as the play end time of the media data to be obtained in the play request sent to the source server. The source server will find that the play start time of play unit 5 is the same as the play end time in the play request sent to the source server when the source server is about to send play unit 5. Then, the source server stops sending media data according to the standard. In this way, the media data obtained from the source server is seamlessly connected with the locally stored data and the problem of the play end time error caused by the loss of partial data is solved.

The above two embodiments of the invention can be combined. When the media server stores at least two media data segments, the media server uses the play start time of the last play unit in the n^{th} locally stored media data segment as the start time of the media data segment to be obtained from the source server, and uses the play start time of the first play unit in the (n+1)^{th} locally stored media data segment as the end time of the n^{th} media data segment to be obtained from the source server. Here, n is a natural number. As in the above example that explains the start time, the media server uses the play start time of the last play unit in the first media data segment (that is, play unit 2) as the start time of the media data segment to be obtained from the source server, and uses the play start time of the first play unit in the locally stored third media data segment (that is, play unit 6) as the end time of the second media data segment to be obtained from the source server.

In an embodiment of the invention, because the play time range parameter of the media data to be obtained from the source server is described in a standard play control protocol as [play start time, play end time), which is a half closed and half open interval, the first play unit obtained from the source server is a play unit that includes the play start time. In the above example, the play time range parameter is described as [2, 6), in which case, the source server will send play unit 2, which is a repetition of the locally stored play unit 2.

One solution is to discard the first play unit in the (n+1)^{th} media data segment obtained from the media server. In the above example, play unit 2 is discarded to prevent the repetition of the locally stored play unit 2.

Another solution is to use an all-open interval to describe the play range of a media data segment when the media server obtains the media data segment from the source server. The start point of the all-open interval is the start time of the media data segment to be obtained from the source server and the end point of the all-open interval is the end time of the media data segment to be obtained from the source server. In this way, the media data segment obtained from the source server may not include the first play unit. In the above example, the all-open interval is (play start time of play unit 2, play start time of play unit 6), that is (2, 6). Thereby, play unit 2 will not be obtained.

In an implementation mode of the invention, if the media server stores only one media data segment, when it is necessary to first play the media data in the locally stored media data segment, in step 103, the media server uses the play start time of the last play unit in the locally stored media data segment as the start time of the media data segment to be obtained from the source server; and in step 104, the media server uses an all-open interval to describe the play range of the media data segment to be obtained from the source server. The start point of the all-open interval is the determined start time of the media data segment to be obtained from the source server.

Assume that the media server stores the media data of play units 0-4 locally and that the play request requests playing the data of play units 0-9, as shown in Table 4.

TABLE 4

| | | | | | | | | | | |
|---|---|---|---|---|---|---|---|---|---|---|
| Play Unit SN | 0 | 1 | 2 | 3 | 4 | 5 | 6 | 7 | 8 | 9 |
| Timestamp Stored by | 0 | 1 | 2 | 3 | 4 | 5 | 6 | 7 | 8 | 9 |
| Source Server | | | | | | | | | | |
| Play Unit SN | 0 | 1 | 2 | 3 | 4 | | | | | |
| Timestamp Stored by | 0 | 1 | 2 | 3 | 4 | | | | | |
| Media Server | | | | | | | | | | |

When the media server uses the standard play protocol RTSP to obtain media data, the play start time specified in the parameter must be later than the play end time of play unit 4 and earlier than or equal to the play start time of play unit 5, so that data starting from play unit 5 can be obtained correctly. But the media server has not obtained the data of play unit 5, and therefore does not know the play start time of play unit 5. A conventional solution is to calculate a presentation duration of play unit 5 according to a default presentation duration. Assuming a default presentation duration of the media server is 2 seconds, the calculated subsequent play start time may be the 6^{th} second. The source server may begin playing from play unit 6 and play unit 5 may be skipped.

To prevent a parameter error caused by unknowing the play start time of play unit 5 and the incorrect positioning caused by the error, the media data processing method in the embodiment of the invention supports not only half-open and half-closed intervals but also all-open intervals. When the media server obtains media data from the source server, the media server uses an all-open interval to indicate the play range of the requested media data. In the foregoing example, when the playing continues after play unit 4, the media server can specify the play start time (for example, the 4^{th} second) of play unit 4 as the start time of the subsequent playing and also specify a play range indicated by an all-open interval. Therefore, when the source server locates the data, the source server will skip data of the 4^{th} second and send data following the 4^{th} second, that is, from play unit 5. In this way, the playing is seamless.

Conversely, if the media server stores only one media data segment locally, when it is necessary to first play a media data segment obtained from the source server, in step 103, the media server can use the play start time of the first play unit in the locally stored media data segment as the end time of the media data segment to be obtained from the source server; and in step 104, the media server can use an all-open interval to indicate the play range of the media data segment to be obtained from the server, where the end point of the open interval is the determined end time of the media data segment to be obtained from the source server.

In the foregoing embodiment of the invention, if the media server already stores the content of play units 5-9 but not the content of play units 0-4, and the user requests playing the play units 0-9, the media server can first request the content of [0, play start time of play unit 5) from the source server. The source server sends media data starting from play unit 0 to the media server, and when play unit 4 is ended (because the play time of play unit 5 is equal to the play end time in the parameter, according to the definition of an open interval, play unit 5 is not in the play range), the media server switches to obtain the content of the locally stored play units 5-9. Thereby, the locally stored media data and the media data obtained from the source server are seamlessly connected.

In another embodiment of the media data processing method, the media server stores the media data obtained from the source server. For example, a first user demands play units 0-5 and the media server stores the play unit 0-5. A second user demands play units 3-9 and the media server will obtain play unit 6-9 from the source server. Then the media server stores the play units 6-9 locally. Therefore, when a third user demands the content, the media server is capable of providing the locally stored play units 0-9. This reduces the amount of data obtained from the source server and reduces the repetitive transmission of data.

In another embodiment of the invention, when the media server obtains the media data in the locally stored media data segment or obtains the media data segment from the source server, the media server provides the obtained media data in the locally stored media data segment and the media data segment obtained from the source server to the terminal in sequence. This means that the media server obtains media data and sends media data to the terminal at the same time. Thereby, the media server does not need to obtain all the requested content before providing the media content to the terminal. The waiting time of the terminal is therefore shorter.

For example, if the terminal demands the media data of play units 2-50 and the media server stores the media data of play units 0-20, the media server first sends the media data of play units 2-20 to the terminal and at the same time, obtain the data of play units 21-50 from the source server. When the media server sends the media data to the terminal, if the media server switches from the media data segment of play units 2-20 to the media date segment of play units 21-50, factors like network delay and response time of the resource server may all cause failure in obtaining the media data in time. To prevent that media data is discontinuous when the media server switches the media data segment, the media server may request buffering the media data of play units 21-50 from the source server before all the media data of play units 2-20 are sent to the terminal, and send the buffered data immediately when all the media data of play units 2-20 are sent to the terminal. When to buffer media data and the amount of buffered data may depend on the response time of the source server if the continuity of data transmission is guaranteed.

In an embodiment of the media data processing method, when the media server obtains media data from the source server, the media server queries the timestamp transition detection interval and the default presentation time of the source server and uses the same timestamp transition detection interval as that used by the source server. When detecting transition, the media server uses a same default presentation time as that used by the source server for the transitioned play units. This is to solve the problem of incorrect positioning of a play range caused by inconsistent transition processing between the media server and the source server.

In the case of exceptions, for example, when an encoder is reset during a recording process or when multiple media files are combined into one media file, the timestamp in the media data stored by the source server may be transitioned, which means that the timestamps carried by two play units, that is, the previous play unit and the subsequent play unit, are both random numbers and that the difference between them is not necessarily the presentation time length of the previous play unit. In this case, the source server checks whether transition has occurred. For example, the source server checks whether the difference between two timestamps is not above 0 or not below 1, and if the difference is not above 0 or not below 1, the source server considers that transition has occurred. In such circumstances, the source server uses the default presentation time (for example, 1 second) as the presentation time of the previous play unit. After the source server sends the media data to the media server, the media server will carry out transition processing accordingly. The standard play control protocol, however, provides no transition processing negotiation mechanism. If the source server and the media server have different transition processing mechanisms, the play range of the media data sent by the source server to the media server will be positioned incorrectly.

For example, the media server has no media data at the beginning and the timestamps carried by play units 0-3 in the source server are respectively the 0^{th} second to the 3^{th} second; the timestamp is transitioned from play unit 4 so that the timestamps carried by play units 4-9 are respectively the 10^{th} second to the 15^{th} second, as shown in Table 5.

TABLE 5

| | | | | | | | | | | |
|---|---|---|---|---|---|---|---|---|---|---|
| Play Unit SN | 0 | 1 | 2 | 3 | 4 | 5 | 6 | 7 | 8 | 9 |
| Timestamp Stored by | 0 | 1 | 2 | 3 | 10 | 11 | 12 | 13 | 14 | 15 |
| Source Server | | | | | | | | | | |
| Timestamp Stored by | | | | | | | | | | |
| Media Server | | | | | | | | | | |

A first user starts playing from the beginning and stops after 5 seconds. The media server obtains the media data of 5 seconds from the source server and stores the media data. The source server detects the transition of the timestamp at play unit 4. The conventional solution is to use the default presentation time as the presentation time of play unit 3 (assume the default presentation time of the source server is 1 second). Therefore, the media data sent to the media server is play units 0-4, as shown in Table 6.

TABLE 6

| | | | | | | | | | | |
|---|---|---|---|---|---|---|---|---|---|---|
| Play Unit SN | 0 | 1 | 2 | 3 | 4 | 5 | 6 | 7 | 8 | 9 |
| Timestamp Stored by | 0 | 1 | 2 | 3 | 10 | 11 | 12 | 13 | 14 | 15 |
| Source Server | | | | | | | | | | |
| Play Unit SN | 0 | 1 | 2 | 3 | 4 | | | | | |
| Timestamp Stored by | 0 | 1 | 2 | 3 | 10 | | | | | |
| Media Server | | | | | | | | | | |

Later, a second user starts playing from the beginning and stops after 10 seconds. The media server first obtains the data of the locally stored five play units and calculates the play start time of play unit 5. The presentation time of play units 0-2 each is 1 second. Because transition occurs at play unit 4, the conventional solution is to calculate the presentation time of play unit 3 according to the default presentation time. In addition, the presentation time of play unit 4 is unknown and is also calculated according to the default presentation time. Assume the default presentation time of the media server is 2 seconds. Then the play start time may be the 7^{th} second. The source server may send media data starting from play unit 7 while discarding play units 5 and 6.

To solve the problem of the incorrect presentation time of play unit 3 caused by transition, an embodiment of the invention adopts a transition processing negotiation mechanism between the media server and the source server. After the media sever accesses the source server, the media server first queries the transition interval and default presentation time that are used by the source server (for example, queries by using the RTSP Get Parameter command) and later, uses the same transition interval as that used by the source server to check whether transition has occurred. If transition has occurred, the media server uses the same default presentation time as that used by the source server for the play unit before the transition. The mechanism prevents the incorrect media content obtained from the media server caused by different transition processing mechanisms used by the media server and the source server.

In an embodiment of the media data processing method, the media server checks whether the media data in the (n+1)^{th} media data segment obtained from the source server is a repetition of the media data in the n^{th} locally stored media data segment by using the feature data of the last play unit in the n^{th} locally stored media data segment as auxiliary positioning data. If the data is repeated, the media server discards the repeated data. Here, n is a natural number.

The feature data here is data that uniquely identifies the play start time. The feature data of a play unit may be one attribute or a combination of some attributes of the media data, or the data obtained by applying a certain algorithm to the attribute of the media data (for example, by using the MD5 to calculate the digest, in which MD5 is short for Message-Digest algorithm 5), depending on the content features. For example, in the case of media data in a Transport Stream (TS) format, Program Clock Reference (PCR), Presentation Time Stamp (PTS), and/or Decode Time Stamp (DTS) attributes may be used as the feature data for positioning; for media data of Motion Picture Experts Group 4 (MPEG4) format, the MD5 digest of the data of a play unit can be used as the feature data of the play unit.

When the media server obtains media data from the source server, the media server may use feature data of the last play unit in the n^{th} locally stored media data segment as auxiliary positioning data and send the feature data to the source server to help the source server check whether the feature data of the play unit to be sent matches the feature data of the last play unit in the locally stored media data segment. Here, n is a natural number.

If the feature data matches the feature data of the last play unit, the source server starts sending media data from the play unit next to the play unit.

The specific practice is:

(1) The media server calculates the play start time T1 and feature data F1 of the last play unit in the locally stored media data segment currently sent to the terminal.

(2) The media server uses the play start time T1 as the start time of the media data segment to be obtained from the source server and uses the feature data F1 as auxiliary positioning data.

(3) After receiving the media data obtaining request of the media server, the source server searches for the related start position P1 in the locally stored media data according to the play start time T1.

The source server checks, starting from the play position corresponding to P1, which play unit has the same feature data as the feature data F1 in the request according to the play direction (forward or backward), and after such play unit is found, sends media data to the media server from the play unit next to the found play unit. If the source server fails to find a play unit that has the same feature data as the feature data F1 in a certain range (configurable in the source server), the source server sends data from the play unit following P1 to the media server.

Therefore, the data sent by the source server to the media server does not include the last play unit in the locally stored media data segment currently sent to the terminal, and thereby, the repeated data transmission is prevented. The media data obtained by the media server is therefore seamlessly connected to the locally stored media data. The network transmission load and server load are reduced and the user experience is enhanced.

In an embodiment of the media data processing method, when the media server obtains a media data segment from the source server according to the determined start time and end time of the media data segment, the media server uses the play start time of the first play unit in the locally stored media data segment as the end time of the media data segment to be obtained from the source server.

FIG. 2 illustrates a structure of the media server in the media data processing method in the first embodiment of the invention. The media server includes a play request receiving unit 201 and a data obtaining unit 202.

The play request receiving unit 201 is configured to receive a play request which carries information of the media content to be played, where the media content information includes an identification of the demanded content (the media content to be played). The play request also includes the start time, end time, and play speed of the demanded content.

The data obtaining unit 202 is configured to: obtain, according to the information of the media content to be played, information of the source server according to the information of the media content to be played and media data from the locally stored media data segment; determine, according to the play time of the locally stored media data segment, the start time and/or end time of the media data segment to be obtained from the source server; and obtain, according to the determined start time and/or end time of the media data segment, the media data segment from the source server.

For the specific steps for the data obtaining unit 202 to perform the above operations, refer to related descriptions of steps 103 and 104.

In the media server provided in the embodiment of the invention, the data obtaining unit 202 determines the start time and end time of the media data segment to be obtained from the source server according to the play time of the locally stored media data and obtains the media data segment from the source server according to the determined start time and end time without the need to obtain complete media data slices from the source server according to the predetermined granularity. Therefore unnecessary transmission of media data is reduced and the network transmission load and server load are relieved.

### Embodiment 2 of the Media Data Processing Method

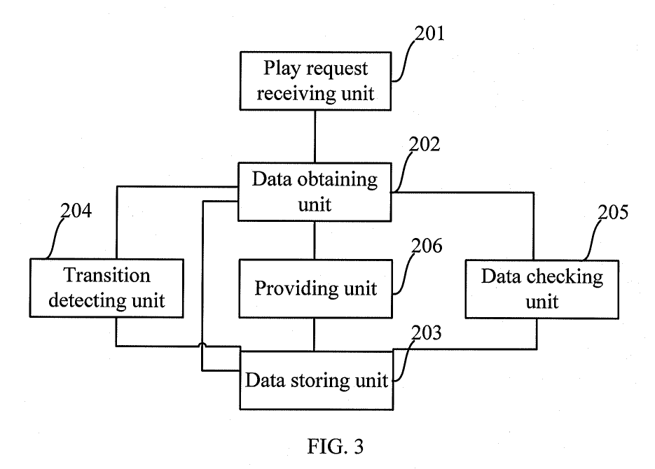

FIG. 3 illustrates a structure of the media server in the media data processing method in a second embodiment of the invention. As shown in FIG. 3, on the basis of the first embodiment of the invention, the media server in the second embodiment of the media data processing method may further include a data storing unit 203, configured to stored media data segments.

Media data segments may be stored according to the play requests of terminals. For example, a first play request requests playing the media data of play units 0-20. After obtaining the media data, the data obtaining unit 202 stores the media data in the data storing unit 203. The media data may be stored as one or multiple slice files. A second play request requests playing the data of play units 40-50 of the same media content. The data obtaining unit 203 obtains the media data of play units 40-50 and stores the media data in the data storing unit 203.

The media server may further include a transition detecting unit 204, configured to: query the timestamp transition detection interval and the default presentation time that are used by the source server and use the same timestamp transition detection interval as that used by the source server; and when transition is detected, use the same default presentation time as that used by the source server for the play unit where the timestamp is transitioned.

The transition detecting unit 204 is added to prevent the incorrect positioning of the media content to be obtained caused by the different transition processing mechanisms used by the media server and the source server when the timestamp in the media data stored by the source server is transitioned in exceptional cases (for example, reset of the encoder in a recording process, or combination of multiple media files to one media file).

Optionally, the media server may further include a data checking unit 205, configured to check whether the media data obtained from the source server is a repetition of the locally stored media data by using the feature data of the last play unit in the locally stored media data segment as auxiliary positioning data, and if the data is repeated, discard the repeated media data.

The feature data here is data that uniquely identifies the play start time. The feature data of a play unit may be one attribute or a combination of some attributes of the media data, or the data obtained by applying a certain algorithm to the attribute of the media data (for example, by using the MD5 algorithm to calculate the digest), depending on the content features. For example, in the case of media data in the TS format, PCR, PTS, and/or DTS attributes may be used as the feature data for positioning; for media data of the MPEG4 format, the MD5 digest of the data of a play unit can be used as the feature data of the play unit. By using the media data checking unit 205 to check for repeated data according to the feature data, repeated transmission of data to the terminal is prevented.

Optionally, the media server includes a providing unit 206, configured to provide the obtained media data in the locally stored media data segment and the media data segment obtained from the source server to the terminal in sequence when obtaining media data from the locally stored media data segment, or when obtaining the media data segment from the source server.

In this way, the media server does not need to obtain all the requested content before providing the media content to the terminal, and therefore, the waiting time of the terminal may be shorter.

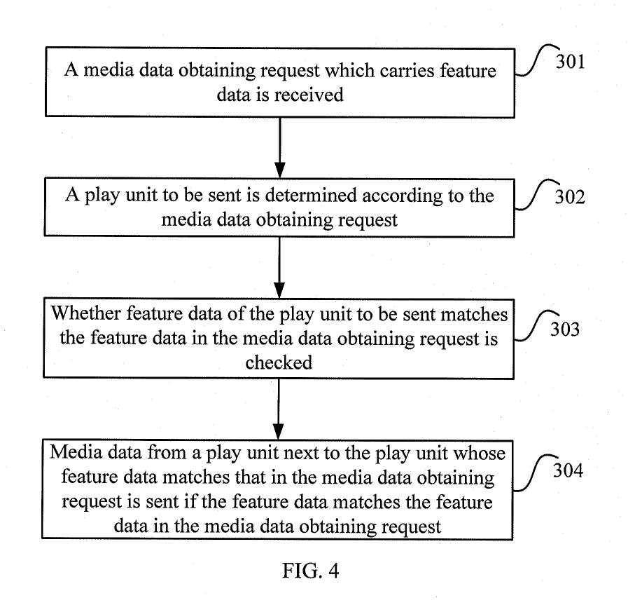

FIG. 4 is a flowchart of the media data processing method in the second embodiment of the invention. The method includes the following steps:

Step 301: A media data obtaining request which carries feature data is received.

The feature data here is data that uniquely identifies the play start time. The feature data of a play unit may be one attribute or a combination of some attributes of the media data, or the data obtained by applying a certain algorithm to the attribute of the media data (for example, using the MD5 algorithm to calculate the digest), depending on the content features. For example, in the case of media data in the TS format, PCR, PTS, and/or DTS attributes may be used as the feature data for positioning; for media data of the MPEG4 format, the MD5 digest of the data of a play unit can be used as the feature data of the play unit. The feature data is generally that of the last play unit in a certain media data segment stored by the media server. The feature data is sent by the media server to the source server.

Step 302: The play unit to be sent is determined according to the media data obtaining request.

The source server locates the media data according to the request and determines the play unit of the media data to be sent.

Step 303: Whether the feature data of the play unit to be sent matches the feature data in the media data obtaining request is checked.

Before sending the requested media data, the source server checks whether the feature data of the play unit to be sent matches the feature data in the request. The source server may define a certain checking range.

Step 304: media data from the play unit next to the play unit whose feature data matches the feature data in the media data obtaining request is sent if the feature data matches the feature data in the media data obtaining request.

If the feature data of a play unit to be sent matches the feature data in the media data obtaining request, it indicates the play unit is already stored in the media server. To prevent sending the same data, the source server sends media data to the media server from the play unit next to the play unit whose feature data matches the feature data in the media data obtaining request.

In the media data processing method provided in the embodiment of the invention, the source server compares feature data to prevent from sending the same media data as stored in the media server. This reduces unnecessary transmission of media data, relieves the network transmission load and server load, and enhances the user experience.

In the method provided in the embodiment of the invention, the source server may also check whether the timestamp of a play unit to be sent is transitioned, and if transition has occurred, the source server changes the timestamps of play units to be sent to continuous timestamps.

In the case of exceptions, for example, when the encoder is reset during a recording process or when multiple media files are combined into one media file, the timestamp in the media data stored by the source server may be transitioned, which means that the timestamps carried by two play units, that is, the previous play unit and the subsequent play unit, are both random numbers and that the difference between them is not necessarily the presentation time length of the previous play unit. In this case, the source server checks whether transition has occurred. For example, the source server checks whether the difference between two timestamps is not above 0 or not below 1, and if the difference is not above 0 or not below 1, the source server considers that transition has occurred. In such circumstances, the source server uses a default presentation time (for example, 1 second) as the presentation time of the previous play unit and changes the timestamps of all play units to be sent to continuous. This may prevent the error of data transmission caused by the transition of timestamps.

In the media data processing method in the embodiment of the invention, the source server sends media data in compliance with a standard play control protocol. This helps the interconnection between systems of different suppliers and reduces the R&D investment caused by the development of a private protocol.

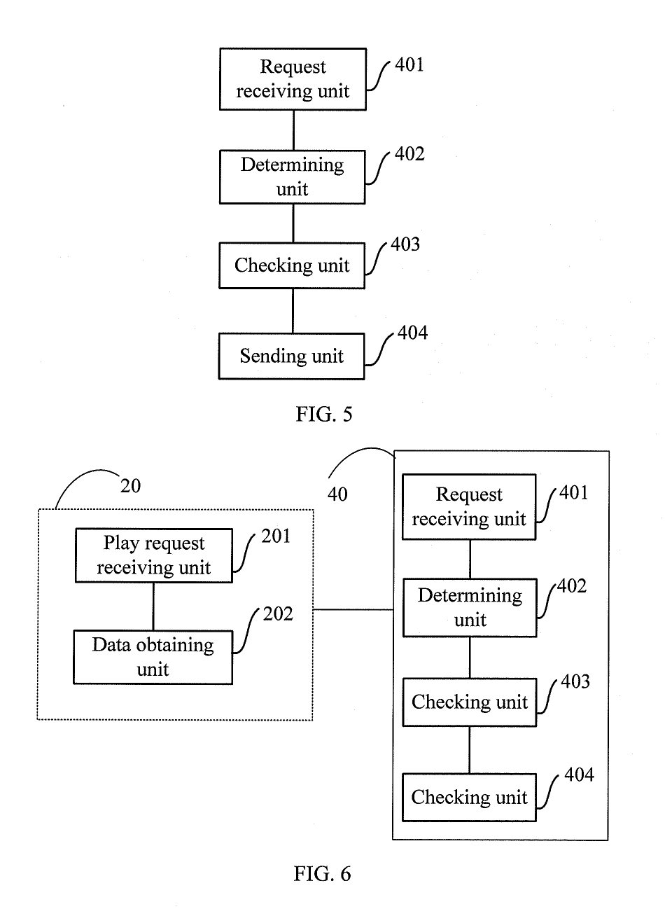

FIG. 5 illustrates a structure of the source server in the media data processing method in the second embodiment of the invention. The source server includes a request receiving unit 401, a determining unit 402, a checking unit 403, and a sending unit 404.

The request receiving unit 401 is configured to receive a media data obtaining request which carries feature data.

The feature data is data that uniquely identifies the play start time. The feature data of a play unit may be one attribute or a combination of some attributes of the media data, or the data obtained by applying a certain algorithm to the attribute of the media data (for example, by using the MD5 algorithm to calculate the digest), depending on the content features. For example, in the case of media data in the TS format, PCR, PTS, and/or DTS attributes may be used as the feature data for positioning; for media data of the MPEG4 format, the MD5 digest of the data of a play unit can be used as the feature data of the play unit. The feature data is generally that of the last play unit in a certain media data segment stored by the media server. The request receiving unit 401 receives the media data obtaining request.

The determining unit 402 is configured to determine the play unit to be sent according to the media data obtaining request.

The source server locates the related media data according to the media data obtaining request and the determining unit 402 determines the play unit of the media data to be sent.

The checking unit 403 is configured to check whether the feature data of the play unit to be sent matches the feature data in the media data obtaining request.

Before sending the requested media data, the checking unit 403 checks whether the feature data of the play unit to be sent matches the feature data in the request. The source server may set a certain checking range.

The sending unit 404 is configured to send media data from the play unit next to the play unit whose feature data matches that in the request.

If the feature data of a play unit to be sent matches the feature data in the media data obtaining request, it indicates the play unit is already stored in the media server. To prevent from sending the same data, the sending unit 404 starts sending media data to the media server from the play unit next to the play unit whose feature data matches that in the request.

The source server in the media data processing method provided in the embodiment of the invention compares feature data to prevent from sending the same media data as stored in the media server. This reduces the unnecessary transmission of media data, relieves the network transmission load and server load, and enhances the user experience.

The embodiment of the invention also provides a media data processing system. FIG. 6 illustrates a structure of the media data processing method in the second embodiment of the media data processing method of the invention. As shown in FIG. 6, the media data processing system includes a media server 20 and a source server 40.

The media server 20 includes the play request receiving unit 201 and the data obtaining unit 202. The play request receiving unit 201 is configured to receive a play request which carries information of the media content to the played, where the media content information includes an identification of demanded content (the media content to be played). The play request also includes the start time, end time, and play speed of the demanded content.

The data obtaining unit 202 is configured to: obtain, according to the information of the media content to be played, information of the source server 40 and media data from the locally stored media data segment; determine, according to the play time of the locally stored media data segment, the start time and/or end time of the media data segment to be obtained from the source server 40; and obtain, according to the determined start time and/or end time of the media data segment, the media data segment from the source server 40.

Optionally, as shown in FIG. 3, the media server 20 further includes the data storing unit 203, configured to store media data segments.

Optionally, as shown in FIG. 3, the media server 20 may further include the transition detecting unit 204, configured to: query the timestamp transition detection interval and the default presentation time that are used by the source server 40 and use the same timestamp transition detection interval as that used by the source server 40; and when transition is detected, use the same default presentation time as that used by the source server 40 for the play unit where the timestamp is transitioned.

Optionally, as shown in FIG. 3, the media server 20 may further include the data checking unit 205, configured to use the feature data of the last play unit in the locally stored media data segment as auxiliary positioning data to check whether the media data obtained from the source server 40 is a repetition of the locally stored media data, and if the data is repeated, discard the repeated media data.

Optionally, as shown in FIG. 3, the media server 20 may further include the providing unit 206, configured to, provide the obtained media data in the locally stored media data segment and the media data segment obtained from the source server 40 to the terminal in sequence when obtaining related media data from the locally stored media data segment, or when obtaining the media data segment from the source server 40.

The source server 40 includes the request receiving unit 401, determining unit 402, checking unit 403, and sending unit 404.

The request receiving unit 401 is configured to receive a media data obtaining request which carries feature data. The determining unit 402 is configured to determine the play unit to be sent according to the media data obtaining request. The checking unit 403 is configured to check whether the feature data of the play unit to be sent matches the feature data in the media data obtaining request. The sending data 404 is configured to send media data from the play unit next to the play unit whose feature data matches that in the media data obtaining request.

It should be noted that no new independent functions need be adopted in the embodiments of the invention. The technical solution of the embodiments of the invention can be implemented by software on a necessary universal hardware platform. Based on such understanding, the technical solution in the embodiments of the invention in nature or the part of the invention contributing to the prior art can be reflected in the form of a software product. The computer software product is stored in a storage medium and includes multiple instructions to execute the methods in the embodiments of the invention. The storage medium here is a Read Only Memory (ROM), a Random Access Memory (RAM), a magnetic disc, or a Compact Disk-Read Only Memory (CD-ROM).

Although the invention has been described through several exemplary embodiments, the invention is not limited to such embodiments. It is apparent that those skilled in the art can make various modifications and variations to the invention without departing from the spirit and scope of the invention. The invention is intended to cover the modifications and variations if they fall within the scope of protection defined by the following claims or their equivalents.

1. A media data processing method, comprising:
receiving a play request which carries information of media content to be played;
obtaining information of a source server according to the information of the media content to be played and obtaining media data from a locally stored media data segment;
determining, according to play time of the locally stored media data segment, at least one of start time and end time of a media data segment to be obtained from the source server; and
obtaining, according to the determined start time and/or end time of the media data segment, the media data segment from the source server.

2. The media data processing method of claim 1, wherein:
the information of the media content to be played comprises start time and end time of the media content to be played;
the determining, according to the play time of the locally stored media data segment, the start time and end time of the media data segment to be obtained from the source server comprises:
determining, according to the play time of the locally stored media data segment and the start time and end time of the media content to be played, at least one of the start time and end time of the media data segment to be obtained from the source server.

3. The media data processing method of claim 1, wherein:
a default start time is set as play start time of the entire media content when the information of the media content to be played does not comprise start time of the media content to be played;
a default end time is set as play end time of the entire media content when the information of the media content to be played does not comprise end time of the media content to be played;
the determining, according to the play time of the locally stored media data segment, at least one of the start time and end time of the media data segment to be obtained from the source server comprises:
determining, according to the play time of the locally stored media data segment and the default start time and end time, at least one of the start time and end time of the media data segment to be obtained from the source server.

4. The media data processing method of claim 1, further comprising: providing the obtained media data in the locally stored media data segment in the media content to be played and the media data segment obtained from the source server to a terminal in sequence when obtaining the media data from the locally stored media data segment or obtaining the media data segment from the source server.

5. The media data processing method of claim 1, wherein the determining the start time of the media data segment to be obtained from the source server comprises: using a play start time of a last play unit in a locally stored n^{th} media data segment as the play start time of an (n+1)^{th} media data segment to be obtained from the source server, wherein n is a natural number; and
the determining the end time of the media data segment to be obtained from the source server comprises: using the play start time of a first play unit in the locally stored (n+1)^{th} media data segment as end time of the n^{th} media data segment to be obtained from the source server, wherein n is a natural number.

6. The media data processing method of claim 5, wherein the obtaining the media data segment from the source server according to at least one of the determined start time and end time of the media data segment comprises: using an all-open interval to indicate a play range of the media data segment, wherein a start point of the all-open interval is the determined start time of the media data segment to be obtained from the source server and an end point of the all-open interval is the determined end time of the media data segment to be obtained from the source server.

7. The method of claim 1, when obtaining the media data segment from the source server, further comprising: querying a timestamp transition detection interval and default presentation time that are used by the source server and using a same timestamp transition detection interval as that used by the source server; and when detecting transition, using the same default presentation time as that used by the source server as presentation time of a timestamp-transitioned play unit.

8. The media data processing method of claim 1, further comprising: checking whether media data in an (n+1)^{th} media data segment obtained from the source server is a repetition of media data in an n^{th} locally stored media data segment by using feature data of a last play unit in an n^{th} locally stored media data segment as auxiliary positioning data, and discarding the repeated data if the media data is repeated, wherein n is a natural number.

9. The media data processing method of claim 1, when obtaining an (n+1)^{th} media data segment from the source server, further comprising: using feature data of a last play unit in an n^{th} locally stored media data segment as auxiliary positioning data and sending the feature data to the source server to help the source server check whether feature data of a play unit to be sent matches the feature data of the last play unit, wherein n is a natural number.

10. A media server, comprising:
a play request receiving unit, configured to receive a play request which carries information of media content to be played; and
a data obtaining unit, configured to: obtain, according to the information of the media content to be played, information of a source server and media data from a locally stored media data segment; determine, according to play time of the locally stored media data segment, start time and/or end time of a media data segment to be obtained from the source server; and obtain, according to at least one of the determined start time and end time of the media data segment, the media data segment from the source server.

11. The media server of claim 10, further comprising:
a transition detecting unit, configured to: query a timestamp transition detection interval and default presentation time that are used by the source server and use a same timestamp transition detection interval as that used by the source server; and when detecting transition, use the same default presentation time as that used by the source server as presentation time of a timestamp-transitioned play unit.

12. The media server of claim 10, further comprising:
a data checking unit, configured to check whether media data of an (n+1)^{th} media data segment obtained from the source server is a repetition of the stored media data by using feature data of a last play unit in an n^{th} locally stored media data segment as auxiliary positioning data and discard the repeated data, wherein n is a natural number if the data is repeated.

13. The media server of claim 10, further comprising:
a providing unit, configured to provide the obtained media data in the locally stored media data segment of the media content to be played and the media data segment obtained from the source server to a terminal in sequence when obtaining the media data from the locally stored media data segment, or when obtaining the media data segment from the source server.

14. A media data processing method, comprising:
receiving a media data obtaining request which carries feature data;
determining a play unit to be sent according to the media data obtaining request;
checking whether feature data of the play unit to be sent matches the feature data in the request; and
sending data from a play unit next to the play unit whose feature data matches that in the media data obtaining request if the feature data of the play unit to be sent matches the feature data in the media data obtaining request, wherein an all-open interval may be used to indicate a play range.

15. A source server, comprising:
a request receiving unit, configured to receive a media data obtaining request which carries feature data;
a determining unit, configured to determine a play unit to be sent according to the media data obtaining request;
a checking unit, configured to check whether feature data of the play unit to be sent matches the feature data in the media data obtaining request; and
a sending unit, configured to send media data from a play unit next to the play unit whose feature data matches that in the media data obtaining request.

16. A media data processing system, comprising a media server and a source server, wherein:
the media server comprises:
a play request receiving unit, configured to receive a play request which carries information of media content to be played; and
a data obtaining unit, configured to: obtain, according to the information of the media content to be played, information of the related source server and media data from a related locally stored media data segment; determine, according to play time of the locally stored media data segment, start time and/or end time of a media data segment to be obtained from the source server; and obtain, according to the determined start time and/or end time of the media data segment, the media data segment from the source server;
the source server comprises:
a request receiving unit, configured to receive a media data obtaining request which carries feature data;
a determining unit, configured to determine a play unit to be sent according to the media data obtaining request;
a checking unit, configured to check whether feature data of the play unit to be sent matches the feature data in the media data obtaining request; and
a sending unit, configured to send media data from a play unit next to the play unit whose feature data matches that in the request.

17. The media data processing system of claim 16, wherein the media server further comprises:
a transition detecting unit, configured to: query a timestamp transition detection interval and default presentation time that are used by the source server and use the same timestamp transition detection interval as that used by the source server; and when transition is detected, use the same default presentation time as that used by the source server as presentation time of a timestamp-transitioned play unit.

18. The media data processing system of claim 16, wherein the media server further comprises:
a providing unit, configured to provide the obtained media data in the locally stored media data segment of the media content to be played and the media data segment obtained from the source server to a terminal in sequence when obtaining the related media data from the locally stored media data segment, or when obtaining the media data segment from the source server.
